(19) United States
(12) Patent Application Publication
(10) Pub. No.: US 2017/0155985 A1
(43) Pub. Date: Jun. 1, 2017

(54) Graphene Based Mesh for Use in Portable Electronic Devices

(71) Applicant: BRAGI GmbH, Munchen (DE)

(72) Inventor: Peter Vincent Boesen, München (DE)

(21) Appl. No.: 15/360,649

(22) Filed: Nov. 23, 2016

Related U.S. Application Data
(60) Provisional application No. 62/260,943, filed on Nov. 30, 2015.

(51) Int. Cl. H04R 1/02; C01B 31/04; H04R 1/10

(52) U.S. Cl. CPC H04R 1/023; H04R 1/1066; H04R 1/1016; C01B 31/0453; G06F 3/165

(57) ABSTRACT

A system, method, and wireless earpiece. The wireless earpiece includes a frame supporting circuitry of the wireless earpiece The frame includes an extension composed of graphene shaped to fit in to an ear canal of a user. The wireless earpiece includes a sleeve fitted over the frame to fit in to the ear canal of the user.

### RELATED APPLICATIONS

This application claims priority to U.S. Provisional Patent Application No. 62/260,943, filed Nov/ 30, 2015, and entitled “Graphene Based Mesh for Use in Portable Electronic Devices System and Method”, hereby incorporated by reference in its entirety.

### BACKGROUND

I. Field of the Disclosure

The illustrative embodiments relate to portable electronic devices. More specifically, but not exclusively, the illustrative embodiments relate to a system, method, and device for utilizing a graphene based mesh in portable electronic devices.

II. Description of the Art

The growth of wearable devices is increasing exponentially. This growth is fostered by the decreasing size of microprocessors, circuitry boards, chips, and other components. In some cases, wearable devices may include earpieces worn in the ears of the user. The positioning of an earpiece at the external auditory canal of a user brings with it many benefits. For example, the user is able to perceive sound directed from a speaker toward the tympanic membrane allowing for a richer auditory experience. This audio may be the speech, music, or other types of sounds. Generating high quality sound in the earpiece may be difficult due to the range of the audio spectrum as well as the small energy sources required. In addition, many earpieces rely on utilization of all of the available space of the external auditory canal luminal area in order to allow for stable placement and position maintenance. Due to the positioning of the earpieces within the ear canal, the earpieces may be damaged or destroyed by a user naturally secreting biological materials, such as sweat or cerumen (e.g., earwax a viscous product produced by the sebaceous glands).

### SUMMARY OF THE DISCLOSURE

One embodiment provides a system, method, and wireless earpiece. The wireless earpiece includes a frame supporting circuitry of the wireless earpiece. The frame includes an extension composed of graphene shaped to fit in to an ear canal of a user. The wireless earpiece includes a sleeve fitted over the frame to fit in to the ear canal of the user.

Another embodiment provides a method for generating graphene layers for utilization with a wireless earpiece. One or more layers of graphene are generated. The one or more layers of graphene are positioned to form an extension to be integrated with a frame of the wireless earpiece. The one or more layers of graphene are secured to the frame of the wireless earpiece.

Yet another embodiment provides a wireless earpiece. The wireless earpiece includes a frame supporting a portion of the internal circuitry including at least a processor, a memory, a transceiver, a speaker, and a microphone. The wireless earpiece further includes a graphene extension configured to be placed in an ear canal of a user, wherein the speaker is positioned at an end of the graphene extension, wherein the graphene extension blocks natural secretions of the ear canal of the user from interfering with the internal circuitry.

### BRIEF DESCRIPTION OF THE DRAWINGS

Illustrated embodiments of the present invention are described in detail below with reference to the attached drawing figures, which are incorporated by reference herein, and where:

FIG. 1 is a pictorial representation of a wireless earpiece in accordance with an illustrative embodiment;

FIG. 2 is a pictorial representation of the wireless earpiece of FIG. 1 inserted in an ear of a user in accordance with an illustrative embodiment;

FIG. 3 is a block diagram of wireless earpieces in accordance with an illustrative embodiment;

FIG. 4 is a flowchart of a process for generating a wireless earpiece in accordance with an illustrative embodiment; and

FIG. 5 illustrates different sizes of sleeves.

### DETAILED DESCRIPTION OF THE DISCLOSURE

The illustrative embodiments provide a wireless earpiece enhanced will a graphene frame, Graphene is an allotrope of carbon in the form of an atomic-scale, hexagonal lattice in which one atom forms each vertex. Graphene is about two hundred and seven (207) times stronger than steel by weight, conducts heat and electricity efficiently and is nearly transparent. The graphene framework provides a mesh that is lighter and thinner than existing materials. The graphene framework protects the delicate electronics of the wireless earpieces while providing a stable platform for other connected portions of the wireless earpiece.

In one embodiment, the graphene is formed in sheets that are then shaped into cones, cylinders and others shapes that are fused for utilization in the wireless earpieces. Graphene or graphene-like structure may also be formed and utilized. In one embodiment, the graphene mesh is fitted into a lumen of a sleeve cover of the wireless earpiece. The graphene framework is light, biocompatible, and easily inserted into silicone sheaths. The graphene may also be shaped into various waveguide structures that more effectively communicate the audio waves. The waveguides are structures that guide waves, such as sound waves, to propagate the signals with minimal loss of energy.

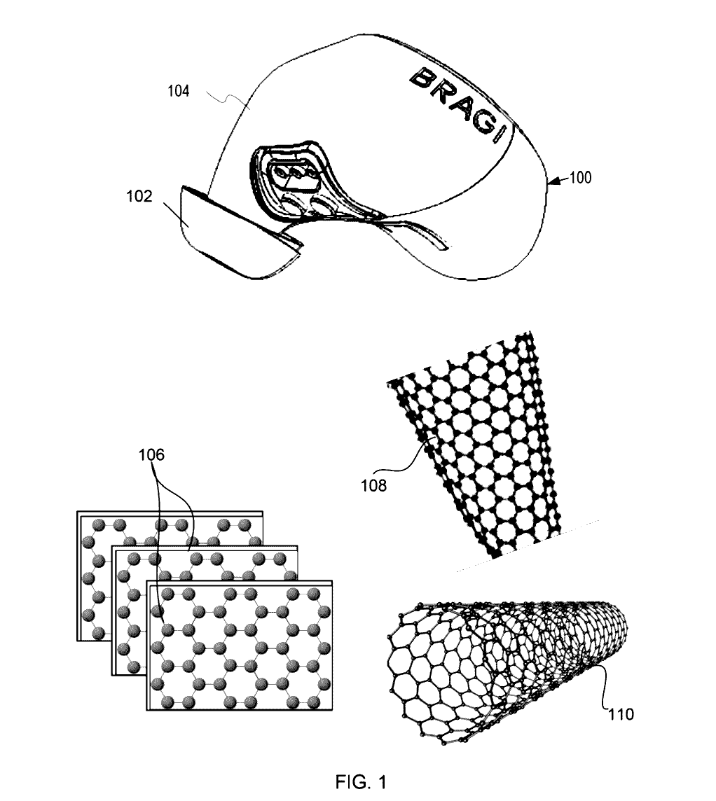

FIG. 1 is a pictorial representation of a wireless earpiece 100 in accordance with au illustrative embodiment. The wireless earpiece 100 is representative of one or both of a matched pair of wireless earpieces, such as a right and left wireless earpiece. The wireless earpiece 100 may have any number of components and structures. In one embodiment, the portion of the wireless earpiece 100 that fits into a user's ear is referred to as a sleeve 102. The sleeve 102 may be a cover or surface, such as lightweight silicone, that fits over a frame 104 of the wireless earpiece or a portion of a frame 104 of the wireless earpiece such as at least a tip portion of the ear piece is covered as is shown. The sleeve 102 is configured to fit inside the user's ear and permits audio content to be communicated through one or more speakers of the wireless earpiece 100 to the user's ear canal, Depending upon the size of a user's ear canal, larger sleeves 102 may be used which cover greater portions of the frame 104 of the wireless earpiece 100.

In one embodiment, sheets 106 of graphene may be layered, wrapped, stacked, folded or otherwise manipulated to form structures, such as a cone 108 and a cylinder 110. The sheets 106 may be created utilizing any number of processes (e.g., liquid phase exfoliation, chemical vapor/thin film deposition, electrochemical synthesis, hydrothermal self-assembly, chemical reduction, micromechanical exfoliation, epitaxial growth, carbon nanotube deposition, nano-scale 3D priming, spin coating, supersonic spray, carbon nanotube unzipping, etc). Graphenite, carbon nanotubes, graphene oxide hydrogels, hyper honeycomb formed of carbon atoms, graphene analogs, or other similar materials may also be utilized to form the frame 104, cone 108, and other portions of the wireless earpiece 100.

In one embodiment, the sleeve 102 is formed from sheets 106, such as the cone 108. The sheets 106 may be layered, shaped, and then secured utilizing other components, such as metallic bands, frameworks, or other structural components. In one embodiment, layers of graphene (e.g., the sheets 106) may be imparted, integrated, or embedded on a substrate or scaffolding that may remain or be removed to form one or more graphene structures of the wireless earpiece 100, such as the sleeve 102. In another embodiment, the sheets 106 may be reinforced utilizing carbon nanotubes. The carbon nanotubes may act as reinforcing bars (e.g., an aerogel, graphene oxide hydrogels, etc.) strengthening the thermal, electrical, and mechanical properties of the cone 108 formed by the sheets 106.

In one embodiment, the sheets 106 of graphene may be soaked in solvent and then overlaid on an underlying substrate. The solvent may be evaporated over time leaving the sheets 106 of graphene that have taken the shape of the underlying structure. For example, the sheets 106 may be overlaid on the frame 104 to form all or portions of the support structure and/or electrical components of the wireless earpiece 100. The sheets 106 may represent entire layers, meshes, lattices, or other configurations.

The cone 108 may include one or more sensors and electronics, such as temperature sensors, speakers, microphones, accelerometers or so forth that may be enhanced based on the properties of graphene. The additional components may be integrated with the cone 108 or positioned within the cone 108.

The cone 108 is highly effective in protecting the delicate components of the wireless earpiece 100. The size and shape of the cone 108 may correspond to the size and shape of the sleeve 102. For example, the cone 108 may protect the wireless earpiece 100 from cerumen. As previously noted, cerumen is a highly viscous product of the sebaceous glands mixed with less-viscous components of the apocrine sweat glands. In many cases, around half of the components of cerumen on a percentage basis is composed of keratin, 10-20% of saturated as well as unsaturated long-chain fatty acids, alcohols, squalene, and cholesterol. In one form, cerumen is also known as earwax. The cone 108 guides and channels the sound generated by one or more speakers for more effective reception of the audio content while protecting the wireless earpiece 100 from the hazards of internal and external materials and biomaterials. In some cases, the graphene may include, capture, or secure other materials to further strengthen and waterproof the cone 108 or other structures thrilled by the sheets 106.

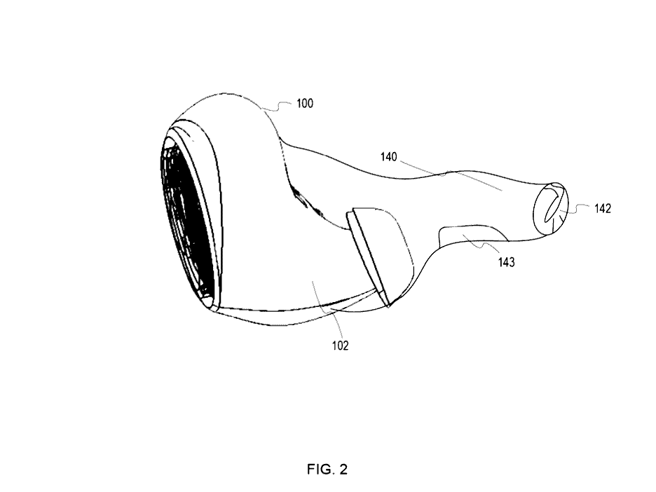

FIG. 2 illustrates the wireless earpiece 100 inserted in an ear of an individual or user. The wireless ear piece 100 fits at least partially into the external auditory canal 140 of the user. A tympanic membrane 142 is shown at the end of the external auditory canal 140.

In one embodiment, the wireless ear piece 100 may completely block the external auditory canal 140 physically or partially block the external auditory canal 140, yet environmental sound may still be produced. Even if the wireless ear piece 100 does not completely block the external auditory canal, cerumen 143 may collect to effectively block portions of the external auditory canal 140. For example, the wireless ear piece 100 may not be able to communicate sounds waves effectively past the cerumen 143. Thus, the ability to reproduce ambient or environmental sound captured from outside of the wireless ear piece 100 and to reproduce it within the wireless earpiece 100 may be advantageous regardless of whether the device itself blocks or does not block the external auditory canal 140 and regardless of whether the combination of the wireless earpiece 100 and cerumen 143 impaction blocks the external auditory canal 140. It is to be further understood that different individuals have external auditory canals of varying sizes and shapes and so the same device which completely blocks the external auditory canal of one user may not necessarily block the external auditory canal of another user.

As previously noted, the sleeve 102 may be formed from one or more graphene layers. The sleeve 102 may interact with the cerumen to protect the internal components of the wireless earpiece 100 that may be shorted, clogged, blocked, or otherwise adversely affected by the cerumen 143. The sleeve 102 may be coated with silicon or other external layers that make the wireless earpiece 100 fit well and comfortable to use. The external layer of the sleeve 102 may be supported by the graphene layers, graphene mesh, graphene framework, or other structure that provides structural, electrical, and chemical stability to the wireless earpiece 100. The sleeve 102 may also represent a separate component that may be integrated with or secured to the frame of the wireless earpiece 100.

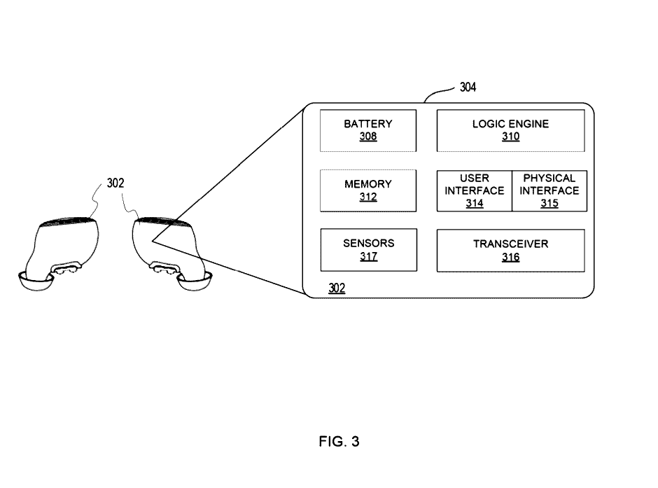

FIG. 3 is a block diagram of wireless earpieces 302 in accordance with an illustrative embodiment. In one embodiment, the wireless earpieces 302 may enhance communications to a user. For example, the wireless earpieces 302 may provide high quality audio. The wireless earpieces 302 may include any number of components, circuits, chips, or other systems.

As shown, the wireless earpieces 302 may be physically or wirelessly linked to each other and one or more electronic devices, such as cellular phones, virtual reality headsets, smart glasses, smart watches, or so forth. User input and commands may be received from either of the wireless earpieces 302 (or other externally connected devices). As previously noted, the wireless earpiece 100 or wireless earpieces may be referred to or described herein as a pair (wireless earpieces) or singularly (wireless earpiece). The description may also refer to components and functionality of each of the wireless earpieces 302 collectively or individually.

The wireless earpieces 302 provide additional biometric and user data that may be further utilized by any number of computing, entertainment, or communications devices. In some embodiments, the wireless earpieces 302 may act as a logging tool for receiving information, data, or measurements made by sensors of the wireless earpieces 302. For example, the wireless earpieces 302 may display pulse, blood oxygenation, location, orientation, distance travelled, calories burned, and so forth as measured by the wireless earpieces 302. The wireless earpieces 302 may have any number of electrical configurations, shapes, and colors and may include various circuitry, connections, and other components.

In one embodiment, the wireless earpieces 302 may include a frame 304, a battery 308, a logic engine 310, a memory 312, a user interface 314, a physical interface 315, a transceiver 316, and sensors 312. The frame 304 is a lightweight and rigid structure for supporting the components of die wireless earpieces 302. In one embodiment, the frame 304 is formed from graphene layers or other carbon structures. The frame 304 may also be composed of any number of other polymers, plastics, composites, metals, or other combinations of materials suitable for personal use by a user. The battery 308 is a power storage device configured to power the wireless earpieces 302. In other embodiments, the battery 308 may represent a fuel cell, thermal electric generator, piezo electric charger, solar charger, ultra-capacitor, or other existing or developing power storage technologies.

The logic engine 310 is the logic that controls the operation and functionality of the wireless earpieces 302. The logic engine 310 may include circuitry, chips, and other digital logic. The logic engine 310 may also include programs, scripts, and instructions that may be implemented to operate the logic engine 310. The logic engine 310 may represent hardware, software, firmware, or any combination thereof. In one embodiment, the logic engine 310 may include one or more processors. The logic engine 310 may also represent an application specific integrated circuit (ASIC), system-on-a-chip (SOC), or field programmable gate array (FPGA). The logic engine 310 may utilize intimation from the sensors 312 to determine the biometric information, data, and readings of the user. The logic engine 302 may utilize this information and other criteria to inform the user of the biometrics e.g., audibly, through an application of a connected device, tactilely, etc).

The logic engine 310 may also process user input to determine commands implemented by the wireless earpieces 302 or sent to the wireless earpieces 304 through the transceiver 316. The user input may be determined by the sensors 317 to determine specific actions to be taken. In one embodiment, the logic engine 310 may implement a macro allowing the user to associate user input as sensed by the sensors 317 with commands.

In one embodiment, a processor included in the logic engine 310 is circuitry or logic enabled to control execution of a set of instructions, The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements.

The memory 312 is a hardware element, device, or recording media configured to store data for subsequent retrieval or access at a later time. The memory 312 may be static or dynamic memory. The memory 312 may include a hard disk, random access memory, cache, removable media drive, mass storage, or configuration suitable as storage for data, instructions, and information. In one embodiment, the memory 312 and the logic engine 310 may be integrated. The memory may use any type of volatile or non-volatile storage techniques and mediums. The memory 312 may store information related to the status of a user, wireless earpieces 302 and other peripherals, such as a wireless device, smart case for the wireless earpieces 302, smart watch, and so forth. In one embodiment, the memory 312 may display instructions or programs for controlling the user interface 714 including one or more LEDs or other light emitting components, speakers, tactile generators (e.g., vibrator), and so forth, The memory 312 may also store the user input information associated with each command.

The transceiver 316 is a component comprising both a transmitter and receiver which may be combined and share common circuitry on a single housing. The transceiver 316 may communicate utilizing Bluetooth, Wi-Fi, ZigBee, Ant+, near field communications, wireless USB, infrared, mobile body area networks, ultra-wideband communications, cellular (e.g., 3G, 4G, 5G, PCS, GSM, etc.) or other suitable radio frequency standards, networks, protocols, or communications. The transceiver 316 may also be a hybrid transceiver that supports a number of different communications. For example, the transceiver 316 may communicate with a wireless device or other systems utilizing wired interfaces (e.g., wires, traces, etc.), NFC or Bluetooth communications.

The components of the wireless earpieces 302 may be electrically connected utilizing any number of wires, contact points, leads, busses, wireless interfaces, or so forth. In one embodiment, the frame 304 may include any of the electrical, structural, and other functional and aesthetic components of the wireless earpieces 302. For example, the wireless earpiece 302 may be fabricated with built in processors, chips, memories, batteries, interconnects, and other components that are integrated with the frame 304. For example, semiconductor manufacturing processes may be utilized to create the wireless earpiece 302 as an integrated and more secure unit. Likewise, graphene or graphene components may be part of the wireless earpiece 302. As a result, functionality, security, shock resistance, waterproof properties, and so forth may be enhanced. In addition, the wireless earpieces 302 may include any number of computing and communications components, devices or elements which may include busses, motherboards, circuits, chips, sensors, ports, interfaces, cards, converters, adapters, connections, transceivers, displays, antennas, and other similar components. The additional computing and communications components may also be integrated with, attached to, or part of the frame 304. The physical interface 315 is hardware interface of the wireless earpieces 302 for connecting and communicating with the wireless devices or other electrical components.

The physical interface 315 may include any number of pins, arms, or connectors for electrically interfacing with the contacts or other interface components of external devices or other charging or synchronization devices. For example, the physical interface 315 may be a micro USB port. In another embodiment, the physical interface 315 may include a wireless inductor for charging the wireless earpieces 302 without a physical connection to a charging device. In one embodiment, the wireless earpieces 302 may be temporarily connected to each other by a removable tether. The tether may include an additional battery, operating switch or interface, communications wire or bus, interfaces, or other components.

The user interface 314 is a hardware interface for receiving commands, instructions, or input through the touch (haptics) of the user, voice commands, or pre-defined motions. The user interface 314 may be utilized to control the other functions of the wireless earpieces 302. The user interface 314 may include the LED array, one or more touch sensitive buttons or portions, a miniature screen or display, or other input/output components. The user interface 314 may be controlled by the user or based on commands received from an external device or a linked wireless device.

In one embodiment, the user may provide feedback by tapping the user interface 314 once, twice, three times, or any number of times. Similarly, a swiping motion may be utilized across or in front of the user interface 314 (e.g., the exterior surface of the wireless earpieces 302) to implement a predefined action. Swiping motions in any number of directions may be associated with specific activities, such as play music, pause, fast forward, rewind, activate a digital assistant (e.g., Siri, Cortana, smart assistant, etc.), end a phone call, make a phone call, and so forth. The swiping motions may also be utilized to control actions and functionality of the wireless earpieces 302 or other external devices (e.g., smart television, camera array, smart watch, etc.). The user may also provide user input by moving her head in a particular direction or motion or based on the user's position or location. For example, the user may utilize voice commands, head gestures, or touch commands to change the content being presented audibly. The user interface 314 may include a camera or other sensors for sensing motions, gestures, or symbols provided as feedback or instructions.

The sensors 317 may include pulse taximeters, accelerometers, gyroscopes, magnetometers, inertial sensors, photo detectors, miniature cameras, and other similar instruments for detecting location, orientation, motion, and so forth. The sensors 317 may also be utilized to gather optical images, data, and measurements and determine an acoustic noise level, electronic noise in the environment, ambient conditions, and so forth. The sensors 317 may provide measurements or data that may be utilized to filter or select images or audio content. Motion or sound may be utilized, however, any number of triggers may be utilized to send commands to externally connected devices.

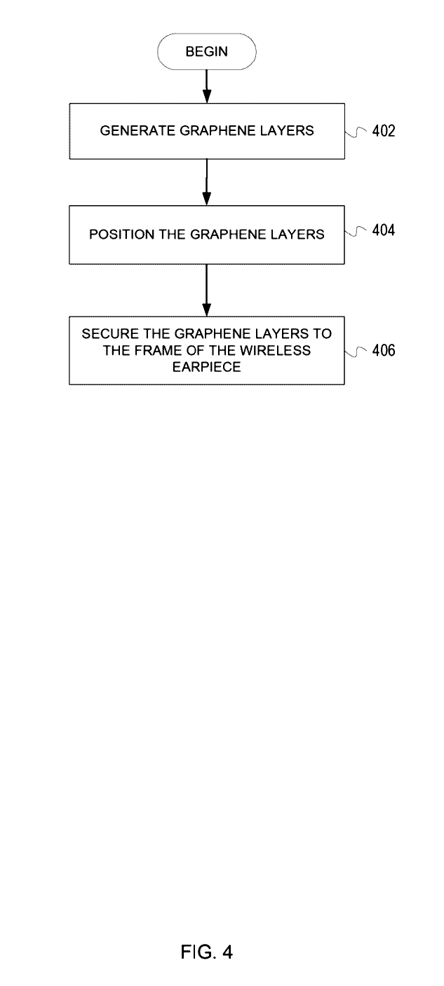

FIG. 4 is a flowchart of a process for generating a wireless earpiece in accordance with an illustrative embodiment. The process of FIG. 4 may be implemented utilizing any number of devices, systems, equipment, facilities, or so forth (referred to generically as a “system”). For example, semiconductor manufacturing facilities and processes (or analogs) may be utilized, The process may be implemented automatically, semi-automatically, manually, or any combination thereof.

The process may begin by generating graphene layers (step 402). The graphene layers may be generated one at a time or utilizing another carbon structure or material. The graphene layers may be generated in any number of ways such as chemical vapor deposition, epitaxial growth, nano-3D printing, or the numerous other methods being developed or currently utilized. In one embodiment, the graphene layers may be generated on a substrate or other framework that may make up one or more portions of the wireless earpieces.

Next, the system positions the graphene layers (step 404). The graphene layers may be layered on top of each other or otherwise positioned. In one embodiment, the graphene layers may be layered on a frame of the wireless earpiece. The graphene layers may also be integrated with a frame of the wireless earpiece. In one embodiment, graphene layers may be bonded to another substrate or material to enhance the effectiveness of the graphene at blocking cerumen, water, or other materials while enhancing strength, rigidity, and other properties of the wireless earpiece (e.g., portion of the frame corresponding to the sleeve fitting in the ear of the user).

Next, the system secures the graphene layers to the frame of the wireless earpiece (step 406). The one or more layers of graphene may be mechanically, structurally, or chemically secured together or to another framework. For example, the graphene layers may be formed into a conical extension that may then be connected to the frame by an adhesive. The graphene my be produced in sheets, mesh structures, or another framework. The process may also be utilized to generate other carbon-based materials. The frame of the wireless earpiece may be previously, concurrently, or simultaneously generated. In another embodiment, the extension formed by the graphene layers may be created before the frame of the wireless earpiece is created. The process of FIG. 4 may be utilized to generate one or more wireless earpieces.

The various components of the wireless earpiece may also be positioned and secured within the graphene extension formed by the one or more graphene layers of FIG. 4. For example, speakers and microphones may be secured within or to the graphene extension.

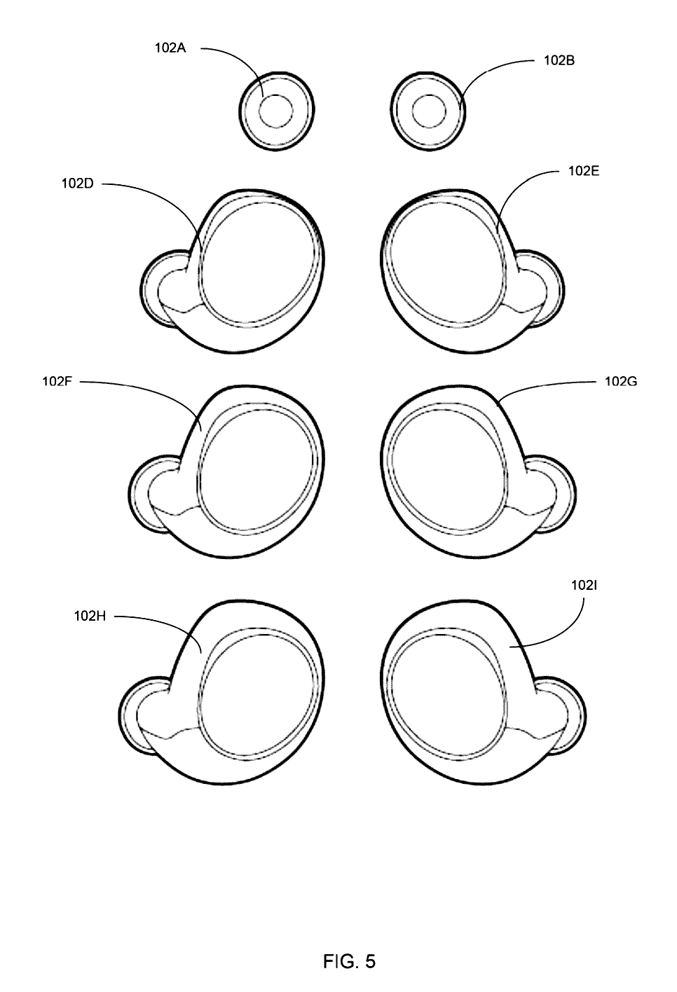

FIG. 5 illustrates different sizes of sleeves that may be used to fit different users. These include extra small sizes 102A, 102B; small sizes 102D, 102E, medium 102F, 102G, and large 102H, 102I. The sizes shown are merely representative and other sizes may be used. It is also to be understood that the shape of the sleeve is related to the ear piece on which it fits. In addition, it is contemplated that sleeves may come in standard sizes or custom sizes such as when they are fitted to specific individuals.

The illustrative embodiments are not to be limited to the particular embodiments described herein. In particular, the illustrative embodiments contemplate numerous variations in the type of ways in which embodiments may be applied. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. A wireless earpiece, comprising:
a frame supporting circuitry of the wireless earpiece, wherein the frame includes an extension composed of graphene shaped to fit in to an ear canal of a user; and
a sleeve fitted over the frame to fit in to the ear canal of the user.

2. The wireless earpiece of claim 1, wherein the frame includes at least a speaker and an ear bone microphone.

3. The wireless earpiece of claim 1, wherein the graphene is printed utilizing a three dimensional primer.

4. The wireless earpiece of claim 1, wherein layers of graphene are layered to form the extension.

5. The wireless earpiece of claim 4, wherein the layers of graphene are adhered to one another to form the extension.

6. The wireless earpiece of claim 1, wherein the sleeve is formed of silicone.

7. The wireless earpiece of claim 1, wherein the extension blocks bodily fluids from entering the wireless earpiece.

8. The wireless earpiece of claim 1, wherein the frame is formed substantially from graphene.

9. A method for generating graphene layers for utilization with a wireless earpiece, comprising:
generating one or more layers of graphene;
positioning the one or more layers of graphene to form an extension to be integrated with a frame of the wireless earpiece; and
securing the graphene layers to the frame.

10. The method of claim 9, further comprising:
depositing carbon atoms on a substrate to generate the one or more layers of graphene.

11. The method of claim 10, wherein the carbon atoms are deposited utilizing chemical vapor deposition.

12. The method of claim 9, wherein the one or more layers of graphene are positioned over a portion of the frame.

13. The method of claim 9, wherein circuitry of the wireless earpiece is mounted within the extension and the frame of the wireless earpiece.

14. The method of claim 9, wherein a sleeve is fitted over the extension thrilled by the one or more layers of graphene.

15. A wireless earpiece, comprising:
a frame supporting a portion of the internal circuitry including at least a processor, a memory, a transceiver, a speaker, and a microphone;
a graphene extension configured to be placed in an ear canal of a user, wherein the speaker is positioned at an end of the graphene extension, wherein the graphene extension blocks natural secretions of the ear canal of the user from interfering with the internal circuitry.

16. The wireless earpiece of claim 15, wherein the frame is formed of graphene.

17. The wireless earpiece of claim 15, wherein the graphene extension is covered by a sleeve to fit the ear canal of the user.

18. The wireless earpiece of claim 15, wherein the graphene extension is connected to the frame by an adhesive.

19. The wireless earpiece of claim 15, wherein the frame and the graphene extension are integrated.

20. The wireless earpiece of claim 15, further comprising:
a processor for executing a set of instructions; and
a memory for storing the set of instructions, wherein the set of instructions are executed to play music or audio selected by the user.
